(19) United States
(12) Patent Application Publication
(10) Pub. No.: US 2025/0310145 A1
(43) Pub. Date: Oct. 2, 2025

(54) MULTIMEDIA OVER COAXIAL ALLIANCE (MoCA) OVER FIBER

(71) Applicant: MaxLinear, Inc., Carlsbad, CA (US)

(72) Inventors: Marcos Martínez Vázquez, Barcelona (ES); Jose Vicente Galán Conejos, Alboraya Valencia (ES); Ehud Kedar, Yehud (IL)

(73) Assignee: MaxLinear, Inc., Carlsbad, CA (US)

(21) Appl. No.: 19/096,494

(22) Filed: Mar. 31, 2025

Related U.S. Application Data
(60) Provisional application No. 63/572,163, filed on Mar. 29, 2024.

(51) Int. Cl. H04L 12/28; H04B 10/2575

(52) U.S. Cl. CPC H04L 12/2801; H04B 10/2575

(57) ABSTRACT

Methods are disclosed for fiber to the room (FTTR). A method may include receiving, at an access point from a station (STA), a modulated signal. The method may include sending, from the access point to a multimedia over coaxial alliance (MoCA) device, the modulated signal. The method may include sending, from the MoCA device to an optical front end, the modulated signal.

### RELATED APPLICATIONS

This application claims the benefit of U.S. Provisional Application No. 63/572,163, filed Mar. 29, 2024, the disclosure of which is incorporated herein by reference in its entirety for all purposes.

The examples discussed in the present disclosure are related to multimedia over coaxial alliance (MoCA) over fiber, gigabit home networking (G.hn), and fiber to the room (FTTR).

### BACKGROUND

Unless otherwise indicated herein, the materials described herein are not prior art to the claims in the present application and are not admitted to be prior art by inclusion in this section.

Fiber-optic communication may be used to transmit information from one location to another by sending pulses of infrared or visible light through an optical fiber. The light may be a carrier wave that is modulated to carry information. Fiber-optic communication may transmit voice, video, and/or telemetry through local area networks or across long distances.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A method may include receiving, at an access point from a station (STA), a modulated signal. The method may include sending, from the access point to a multimedia over coaxial alliance (MoCA) device, the modulated signal. The method may include sending, from the MoCA device to an optical front end, the modulated signal.

A method for fiber to the room may include receiving, at an access point from a user equipment, a modulated signal. The method may include sending, from the access point to a gigabit home networking (G.hn) adapter, the modulated signal. The method may include sending, from the G.hn adapter to a passive splitter, the modulated signal.

A repeater may include an access point that may receive a modulated signal. The repeater may include a switch. The repeater may include a communication device that may communicate with a gateway via an optical front end.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example passive optical network (PON) system.

FIG. 2 illustrates an example optical Ethernet system.

FIG. 3A illustrates an example optical module.

FIG. 3B illustrates an example optical module.

FIG. 4 illustrates an example system for fiber to the room (FTTR) with multimedia over coaxial alliance (MoCA).

FIG. 5 illustrates an example system for fiber to the room (FTTR) with multimedia over coaxial alliance (MoCA) with a coaxial extension.

FIG. 6 illustrates an example system for fiber to the room (FTTR) with gigabit home networking (G.hn).

FIG. 7A illustrates an example optical front end.

FIG. 7B illustrates an example optical front end.

FIG. 8 illustrates a block diagram of an example communication system configured to perform fiber to the room (FTTR).

FIG. 9 illustrates an example process flow for fiber to the room (FTTR).

FIG. 10 illustrates an example process flow for fiber to the room (FTTR).

FIG. 11 illustrates an example process flow for fiber to the room (FTTR).

FIG. 12 illustrates a diagrammatic representation of a machine in the example form of a computing device within which a set of instructions, for causing the machine to perform any one or more of the methods discussed herein, may be executed.

### DESCRIPTION

Fiber infrastructure may be used to distribute a wireless local area network signal throughout a location. There are two different ways of distributing a Wi-Fi® signal through a home using fiber infrastructure. In some examples, xPON systems may be simplified to reduce cost (e.g., @2.5 Gbps). In some examples, optical Ethernet peer-to-peer (P2P) connections may be created and an external switch (e.g., @1 Gbps) may be used.

The Multimedia over Coax Alliance (MoCA) is an international standards organization that publishes specifications for networking over coaxial cable. Gigabit Home Networking (G.hn) is a specification for wired home networking that supports speeds up to 2 Gbit/s and operates over four kinds of legacy wires: telephone wiring, coaxial cables, power lines, and plastic optical fiber. Both of these specifications may be used in conjunction with fiber infrastructure (preexisting and new) to distribute the Wi-Fi® signal through the home. In addition or alternatively, invisible fiber may be used to distribute a Wi-Fi® signal throughout the home. Different chipsets may be used to facilitate the distribution of a Wi-Fi® signal throughout a home including G.hn/MoCA chipsets, which may be used to provide 1 Gbps/2.5 Gbps communication speeds.

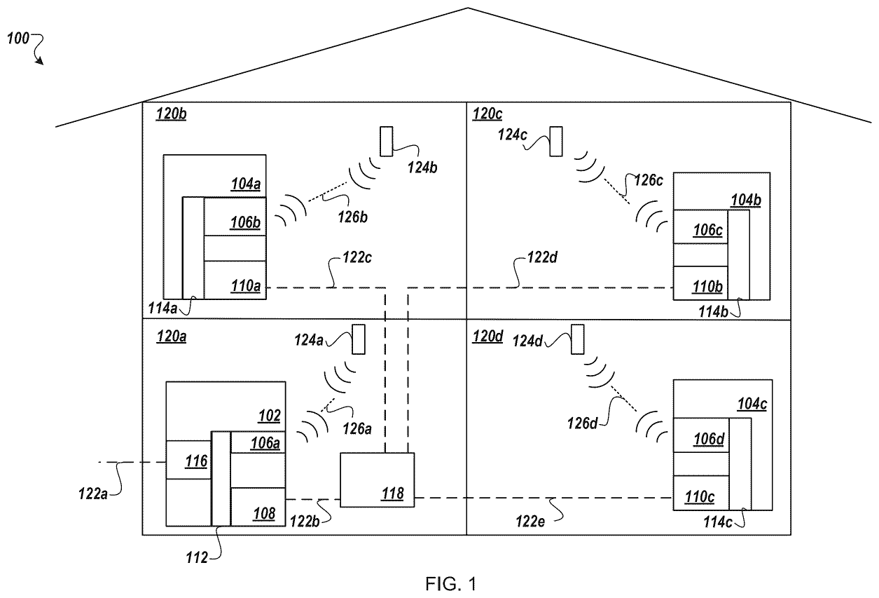

As illustrated in the diagram 100 in FIG. 1, Gigabit passive optical networks (GPON) may be used to provide fiber to the room (e.g., rooms 120a, 120b, 120c, 120d). The gateway 102 may include an access point 106a, a host 112, an optical line terminal (OLT) 108, and an optical network terminal (ONT) 116 (which may be coupled to invisible fiber 122a). The optical line terminal 108 may be coupled to a passive splitter 118 via an invisible fiber 122b. The passive splitter 118 may be coupled to one or more repeaters 104a, 104b, 104c using invisible fiber 122c, 122d, 122e. The invisible fiber 122c, 122d, 122e may couple the passive splitter 118 to an ONT 110a, 110b, 110c of the one or more repeaters 104a, 104b, 104c. The one or more repeaters 104a, 104b, 104c may include an ONT 110a, 110b, 110c, respectively, a bridge 114a, 114b, 114c, respectively, and an access point 106b, 106c, 106d, respectively. The bridge 114a, 114b, 114c may couple the ONT 110a, 110b, 110c to the access point 106b, 106c, 106d. The access points 106a, 106b, 106c, 106d may communicate with user equipments 124a, 124b, 124c, 124d via a WLAN (wireless local area network) (e.g., Wi-Fi®) connection 126a, 126b, 126c, 126d. The performance of the fiber to the room may be e.g., 2.5 Gbps.

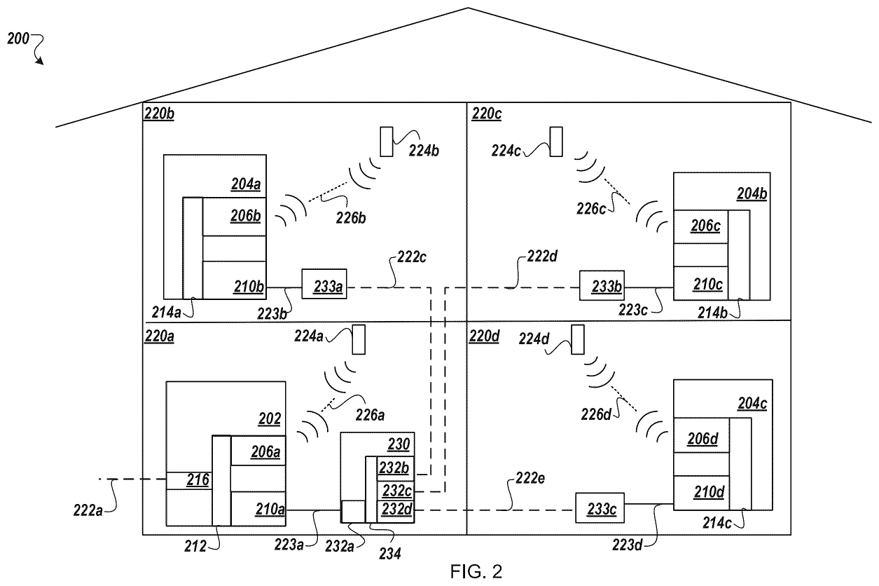

As illustrated in the diagram 200 of rooms 220a, 220b, 220c, 220d in FIG. 2, optical Ethernet technology may be used with gateways 202 and repeaters 204a, 204b, 204c and may have performance of about 1 Gbps. The gateway 202 may include an ONT 216 coupled to a host 212. The ONT may be coupled to invisible fiber 222a. The host 212 may be coupled to an access point 206a and an optical Ethernet connector 210a. The optical Ethernet connector 210a may be coupled to an optical Ethernet connector 232a of an active splitter 230 using a Catx connection 223a.

The optical Ethernet connector 232a on the active splitter 230 may be coupled to a switch 234. The switch 234 may be coupled to one or more Ethernet connectors 232b, 232c, 232d. The one or more Ethernet connectors 232b, 232c, 232d may be coupled to one or more repeaters 204a, 204b, 204c via invisible fiber 222c, 222d, 222e which may be coupled to an optical front end 233a, 233b, 233c of the one or more repeaters 204a, 204b, 204c. The optical front end 233a, 233b, 233c of the repeater 204a, 204b, 204c may be coupled to an Ethernet connector 210b, 210c, 210d using a Catx connection 223b, 223c, 223d.

The optical front end 233a, 233b, 233c of the one or more repeaters 204a, 204b, 204c may be coupled to one or more Ethernet connectors 210b, 210c, 210d. The one or more Ethernet connectors 210b, 210c, 210d of the one or more repeaters 204a, 204b, 204c may be coupled to a switch 214a, 214b, 214c. The switch 214a, 214b, 214c may be coupled to an access point 206b, 206c, 206d of the repeater 204a, 204b, 204c. The access point 206b, 206c, 206d of the repeater 204a, 204b, 204c may communicate with a user equipment 224b, 224c, 224d using a WLAN connection (e.g., Wi-Fi®) 226b, 226c, 226d. The access point 206a of the gateway 202 may communicate with a user equipment 224a using a WLAN connection (e.g., Wi-FI®) 226a.

In one example, MoCA and G.hn technologies may be used to offer a 1 Gbps/2.5 Gbps FTTR_system without additional software and with minimal additional external hardware. The system may transport the modulated signal over the fiber (OFDM modulation over fiber). The additional optical module may include a laser and photodiode.

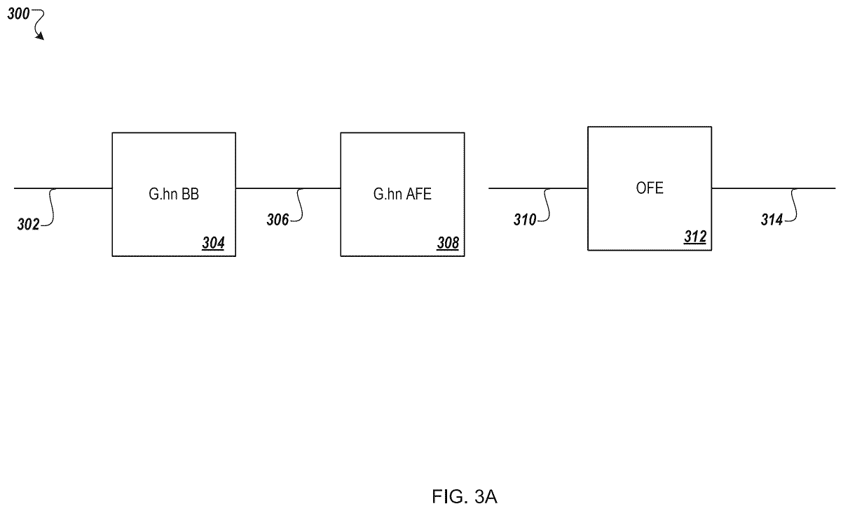

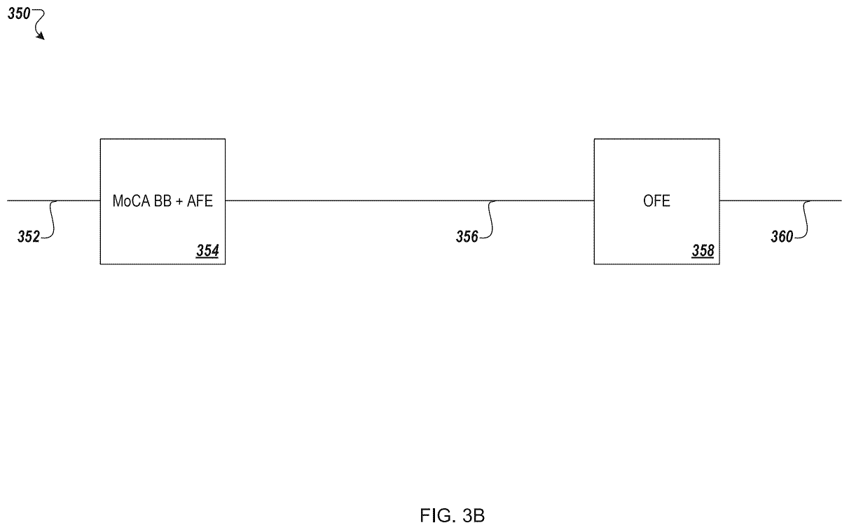

As illustrated in the block diagram 300 in FIG. 3A, an Ethernet connection 302 may be coupled to a G.hn broadband processor 304 which may be coupled to a G.hn analog front end 308 via a connection 306. The G.hn analog front end 308 may be coupled to the optical front end 312 using a connection 310. The optical front end 312 may receive a signal having a frequency range between 0 and 200 MHz using the connection 310. The optical front end 312 may transmit a signal in a frequency range of from −100 MHz to +100 MHz using the connection 314.

As illustrated in the block diagram 350 in FIG. 3B, an Ethernet connection 352 may be coupled to a MoCa baseband processor and analog front end 354 which may be coupled to an optical front end 358 via the connection 356. The optical front end 358 may receive a signal having a frequency of from 500 to 1 GHz. The optical front end 358 may transmit a signal having a frequency of from about −500 MHz to about 500 MHz using connection 360.

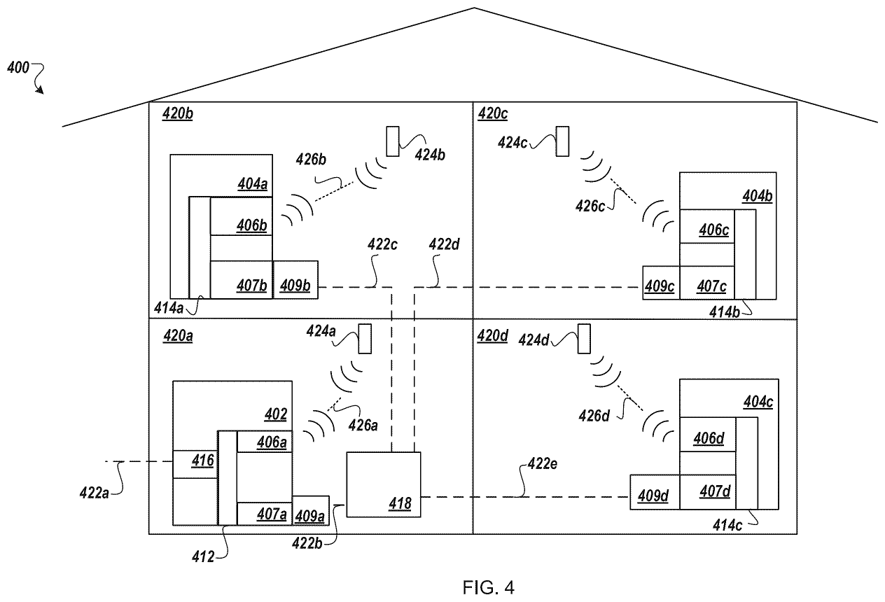

As illustrated in the diagram 400 of rooms 420a, 420b, 420c, 420d in FIG. 4, a performance of 2.5 Gbps may be effectuated. The optical front end 409a may be coupled to the gateway 402 using a dedicated optical port or a small form-factor pluggable (SFP) port in the gateway using a coaxial connection or a fiber connection.

The gateway 402 may include an access point 406a, a host 412, an ONT 416 (which may be coupled to invisible fiber 422a), a MoCA device 407a, and an optical front end 409a. The optical front end 409a may be coupled to a passive splitter 418 via invisible fiber 422b. The passive splitter 418 may be coupled via invisible fiber 422c, 422d, 422e to one or more repeaters 404a, 404b, 404c via an optical front end 409b, 409c, 409d of the one or more repeaters 404a, 404b, 404c. The one or more repeaters 404a, 404b, 404c may include an access point 406b, 406c, 406d, a switch 414a, 414b, 414c, a MoCA device 407b, 407c, 407d, and an optical front end 409b, 409c, 409d. The access point 406b, 406c, 406d of the repeater 404a, 404b, 404c may communicate with a user equipment 424b, 424c, 424d via a WLAN connection (e.g., Wi-Fi®) 426b, 426c, 426d. The access point of the gateway may communicate with a user equipment 424a via a WLAN connection (e.g., Wi-Fi®) 426a.

MoCAoFiber may be used to extend existing coax-based networks (MoCA). A hybrid splitter (active element) may be connected to the gateway. The hybrid splitter may include an active coaxial to optical media converter.

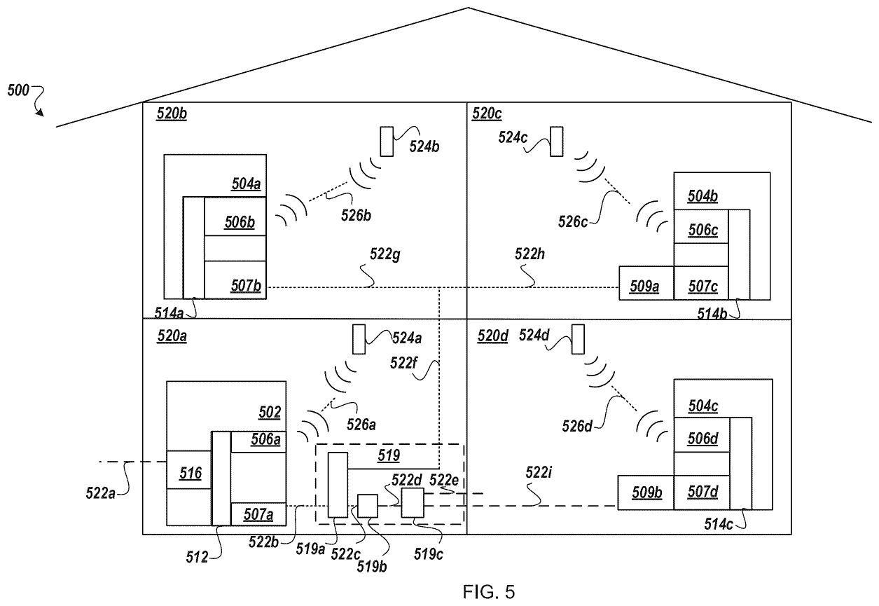

As illustrated in the diagram 500 of rooms 520a, 520b, 520c, 520d in FIG. 5, the gateway 502 may include an access point 506a, a host 512, a MoCA device 507a, and an ONT 516 (which may be coupled to invisible fiber 522a). The MoCA device 507a may be coupled to a hybrid splitter 519 using a coaxial connection 522b. The hybrid splitter 519 may be an active device that may include a coaxial splitter 519a, an optical front end 519b, and an optical passive splitter 519c. The coaxial splitter 519a may be coupled to the optical front end 519b via the coaxial connection 522c. The optical front end maybe coupled to the optical passive splitter 519c via the invisible fiber 522d. The optical passive splitter 519c may be coupled to one or more repeaters 504c using invisible fiber 522i and may be coupled to other components using invisible fiber 522e. The coaxial splitter 519a may be coupled to one or more repeaters 504a, 504b via a preexisting coaxial connection 522f, 522g, 522h.

The repeater 504a, 504b may be coupled to the coaxial splitter 519a of the hybrid splitter 519 using a MoCA device (e.g., MoCA device 507b) or an optical front end (e.g., optical front end 509a). The optical passive splitter 519c may be coupled to the one or more repeaters 504c using an optical front end 509b of the repeater 504c.

The one or more repeaters 504a, 504b, 504c may include an access point 506b, 506c, 506d, a switch 514a, 514b, 514c, a MoCA device 507b, 507c, 507d, and an optical front end 509a, 509b. The access point 506b, 506c, 506d of the repeater 504a, 504b, 504c may communicate with a user equipment 524b, 524c, 524d via a WLAN connection (e.g., Wi-Fi®) 526b, 526c, 526d. The access point 506a of the gateway 502 may communicate with a user equipment 524a via a WLAN connection (e.g., Wi-Fi®) 526a.

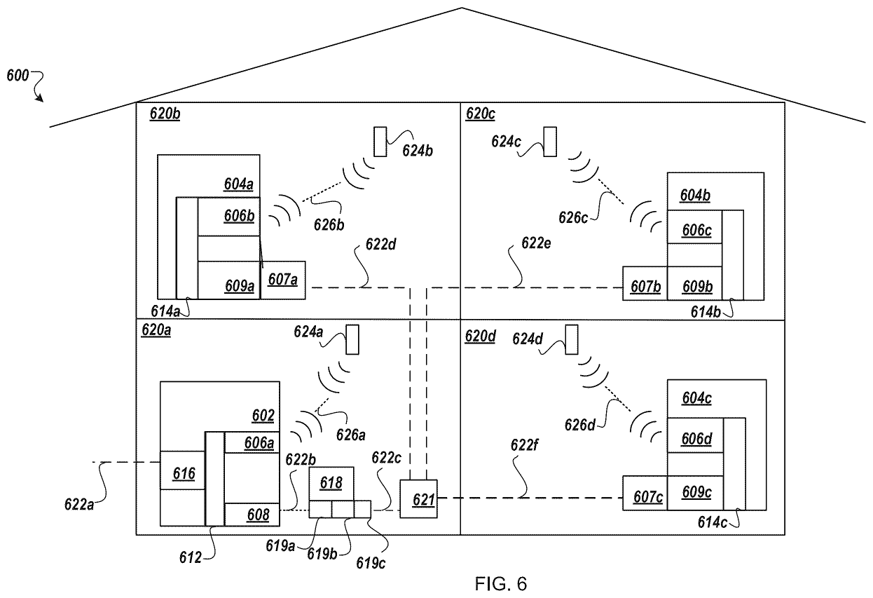

Fiber to the room (e.g., rooms 620a, 620b, 620c, 620d) may be effectuated using G.hn to provide performance of about 1 Gbps. As illustrated in the diagram 600 in FIG. 6, the gateway 602 may include an optical network terminal 616 (which may be coupled to invisible fiber 622a), a host 612, an access point 606a, and an Ethernet connector 608. The Ethernet connector 608 may be connected via a Catx connection 622b to an Ethernet connector 619a on a G.hn adapter 618.

The G.hn adapter 618 may include the Ethernet connector 619a, a G.hn processor 619b, and an optical front end 619c. The optical front end 619c may be coupled to a passive splitter 621 via invisible fiber 622c. The passive splitter 621 may be coupled to an optical front end 607a, 607b, 607c of one or more repeaters 604a, 604b, 604c, e.g., using invisible fiber 622d, 622e, 622f. The one or more repeaters 604a, 604b, 604c may include an optical front end 607a, 607b, 607c that may be coupled to a G.hn processor 609a, 609b, 609c which may be coupled to a switch 614a, 614b, 614c which may be coupled to an access point 606b, 606c, 606d. The access point 606b, 606c, 606d may communicate with a user equipment 624b, 624c, 624d using WLAN communication (e.g., Wi-Fi®) 626b, 626c, 626d. The access point 606a of the gateway 602 may communicate with a user equipment 624a using WLAN communication (e.g., Wi-Fi®) 626a.

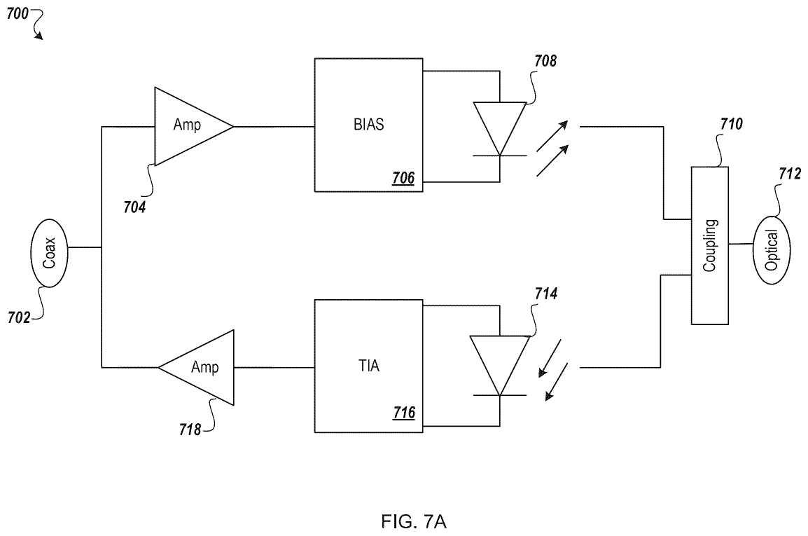

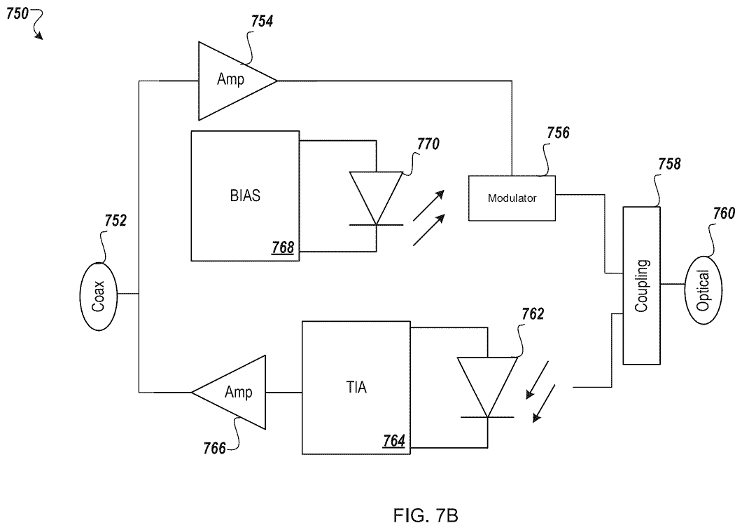

As illustrated in the diagram 700 in FIG. 7A, in a first direction, the optical front end may include a coaxial connector 702 that may receive a coaxial signal. The coaxial connector 702 may be coupled to one or more amplifiers 704. The one or more amplifiers 704 may be coupled to a bias circuit 706. The bias circuit 706 may be coupled to a photodiode 708. The photodiode 708 may communicate with an optical coupling 710 which may transmit an optical signal 712.

In a second direction, the optical signal 712 may be communicated to an optical coupling 710 which may be communicated to a photodiode 714. The photodiode 714 may be coupled to a trans-impedance amplifier (TIA) 716. The TIA 716 may be coupled to one or more amplifiers 718. The one or more amplifiers 718 may be coupled to a coaxial connector 702 which may communicate a coaxial signal.

As illustrated in the diagram 750 in FIG. 7B, in a first direction, an optical front end may include a coaxial connector 752 that may direct a coaxial signal. The coaxial signal may be directed to one or more amplifiers 754. The one or more amplifiers 754 may direct the amplified signal to a modulator 756. The modulator 756 may receive an optical signal from a photodiode 770 which may be coupled to a bias circuit 768. The modulator 756 may modulate the receive signals and send the modulated signals to an optical coupling 758 to an optical signal 760.

In a second direction, the optical signal 760 may be directed to an optical coupling 758. The optical coupling 758 may be directed to a photodiode 762 which may be coupled to a TIA 764. The TIA 764 may be coupled to one or more amplifiers 766. The one or more amplifiers 766 may be coupled to a coaxial connector 752. The coaxial connector 752 may be operable to direct a coaxial signal.

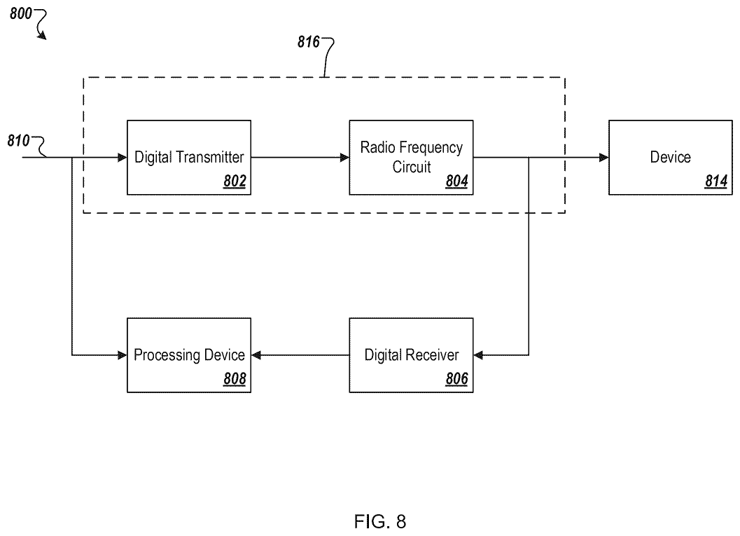

FIG. 8 illustrates a block diagram of an example communication system 800 configured for fiber to the room, in accordance with at least one example described in the present disclosure. The communication system 800 may include a digital transmitter 802, a radio frequency circuit 804, a device 814, a digital receiver 806, and a processing device 808. The digital transmitter 802 and the processing device may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct radio frequency (RF) sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the transceiver 816 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 818 may be configured to receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

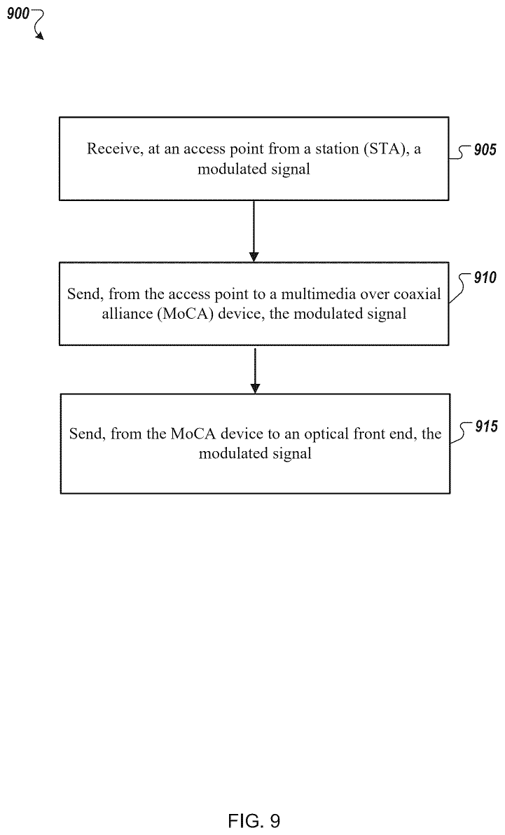

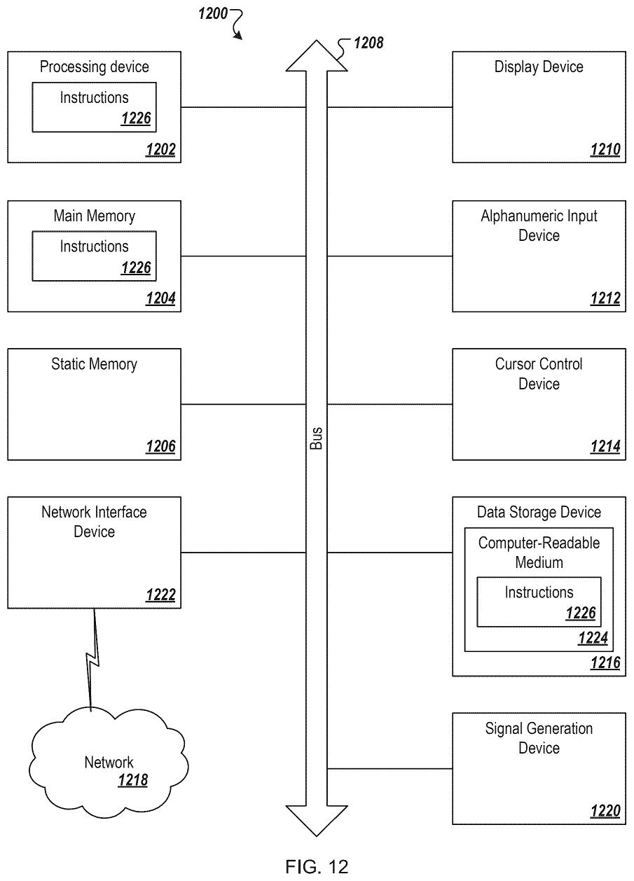

FIG. 9 illustrates a process flow of an example method 900 of fiber to the room, in accordance with at least one example described in the present disclosure. The method 900 may be arranged in accordance with at least one example described in the present disclosure. The method 900 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 900 may begin at block 905 where the processing logic may receive, at an access point from a station (STA), a modulated signal. At block 910, the processing logic may send, from the access point to a multimedia over coaxial alliance (MoCA) device, the modulated signal. At block 915, the processing logic may send, from the MoCA device to an optical front end, the modulated signal.

The method may include sending, from the optical front end to a passive splitter for transmission to one or more repeaters, the modulated signal.

Modifications, additions, or omissions may be made to the method 900 without departing from the scope of the present disclosure. For example, in some examples, the method 900 may include any number of other components that may not be explicitly illustrated or described.

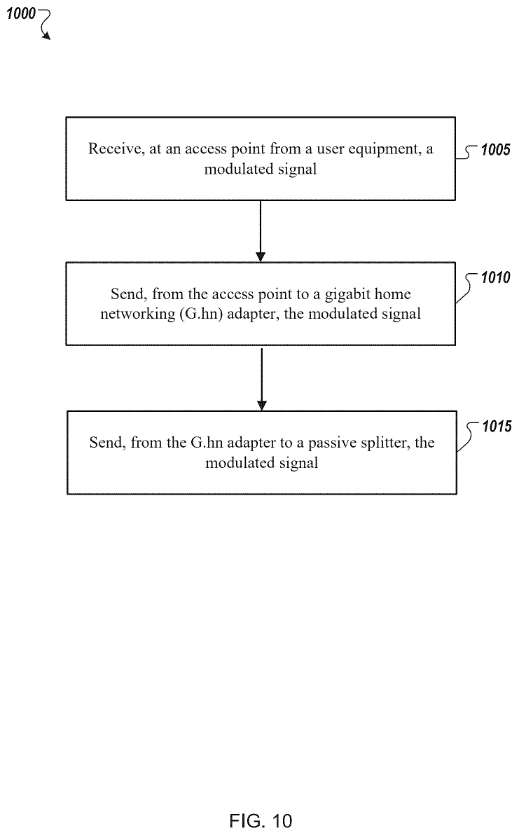

FIG. 10 illustrates a process flow of an example method 1000 of fiber to the room, in accordance with at least one example described in the present disclosure. The method 1000 may be arranged in accordance with at least one example described in the present disclosure. The method 1000 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 1000 may begin at block 1005 where the processing logic may receive, at an access point from a user equipment, a modulated signal. At block 1010, the processing logic may send, from the access point to a gigabit home networking (G.hn) adapter, the modulated signal. At block 1015, the processing logic may send, from the G.hn adapter to a passive splitter, the modulated signal.

Modifications, additions, or omissions may be made to the method 1000 without departing from the scope of the present disclosure. For example, in some examples, the method 1000 may include any number of other components that may not be explicitly illustrated or described.

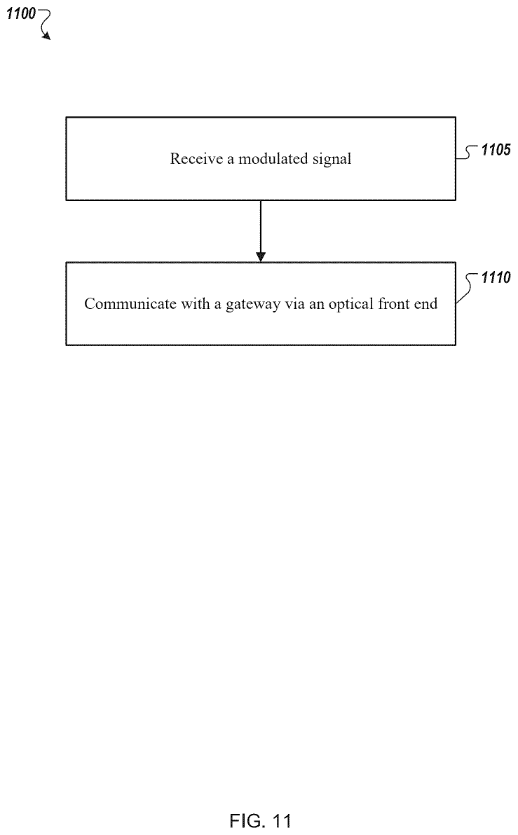

FIG. 11 illustrates a process flow of an example method 1100 of fiber to the room, in accordance with at least one example described in the present disclosure. The method 1100 may be arranged in accordance with at least one example described in the present disclosure. The method 1100 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 1100 may begin at block 1105 where the processing logic may receive a modulated signal. At block 1110, the processing logic may communicate with a gateway via an optical front end.

Modifications, additions, or omissions may be made to the method 1100 without departing from the scope of the present disclosure. For example, in some examples, the method 1100 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 12 illustrates a diagrammatic representation of a machine in the example form of a computing device 1200 within which a set of instructions, for causing the machine to perform any one or more of the methods discussed herein, may be executed. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method for fiber to the room (FTTR), comprising:
receiving, at an access point from a station (STA), a modulated signal;
sending, from the access point to a multimedia over coaxial alliance (MoCA) device, the modulated signal; and
sending, from the MoCA device to an optical front end, the modulated signal.

2. The method of claim 1, further comprising:
sending, from the optical front end to a passive splitter for transmission to one or more repeaters, the modulated signal.

3. The method of claim 2, wherein the passive splitter is operable to communicate using invisible fiber.

4. The method of claim 1, wherein the optical front end is housed in a hybrid splitter.

5. The method of claim 4, wherein the hybrid splitter includes one or more of a coax splitter or an optical passive splitter.

6. The method of claim 4, wherein the hybrid splitter is operable to communicate using preexisting coax.

7. The method of claim 1, wherein the modulated signal is modulated using orthogonal frequency division multiplexing (OFDM).

8. The method of claim 1, further comprising:
coupling the optical front end to the MoCA device using one or more of a dedicated optical port or a small form-factor pluggable (SFP) port.

9. The method of claim 1, wherein the access point and the MoCA device are housed in a gateway.

10. The method of claim 1, wherein the optical front end comprises one or more of an amplifier, a bias, a trans-impedance amplifier, a photodiode, or a modulator.

11. A method for fiber to the room (FTTR), comprising:
receiving, at an access point from a user equipment, a modulated signal;
sending, from the access point to a gigabit home networking (G.hn) adapter, the modulated signal; and
sending, from the G.hn adapter to a passive splitter, the modulated signal.

12. The method of claim 11, wherein the modulated signal is modulated using orthogonal frequency division multiplexing (OFDM).

13. The method of claim 11, further comprising:
communicating the modulated signal using invisible fiber.

14. The method of claim 11, wherein the G.hn adaptor includes an optical front end.

15. A repeater, comprising:
an access point operable to receive a modulated signal;
a switch; and
a communication device operable to communicate with a gateway via an optical front end.

16. The repeater of claim 15, wherein the communication device is a multimedia over coaxial alliance (MoCA) device.

17. The repeater of claim 16, wherein the MoCA device is operable to communicate with a gateway using preexisting coax.

18. The repeater of claim 15, wherein the communication device is a gigabit home networking (G.hn) adapter.

19. The repeater of claim 18, wherein the G.hn adaptor is operable to communicate with a gateway using invisible fiber.

20. The repeater of claim 15, wherein the G.hn adaptor is operable to communicate with the gateway using a passive splitter.
